(19) United States
(12) Patent Application Publication
(10) Pub. No.: US 2010/0091369 A1
(43) Pub. Date: Apr. 15, 2010

(54) DOUBLE-LAYER GRATING

(75) Inventor: John Hoose, Fairport, NY (US)

Correspondence Address: RISSMAN HENDRICKS & OLIVERIO, LLP, 100 Cambridge Street, Suite 2101, BOSTON, MA, 02114, US

(73) Assignee: LUMELLA INC., Fairport, NY (US)

(21) Appl. No.: 12/579,134

(22) Filed: Oct. 14, 2009

Related U.S. Application Data
(60) Provisional application No. 61/196,114, filed on Oct. 15, 2008.

(51) Int. Cl. G02B 5/18; B44C 1/22

(52) U.S. Cl. 359/568; 359/576; 216/24

(57) ABSTRACT

A double-layer grating structure for efficient retroreflection of incident radiation and efficient transmission of the undiffracted incident radiation is disclosed. The grating is constructed of two spaced-apart layers of periodically arranged metal stripes, wherein the stripes in one layer overlap with gaps between the stripes in the second layer. The layers are encapsulated with a dielectric material. A method for producing such grating is also described.

### CROSS-REFERENCE TO RELATED APPLICATIONS

This application claims priority to U.S. Provisional Application Ser. No. 61/196,114, filed Oct. 15, 2008, the entire content is incorporated herein by reference.

### FIELD OF THE INVENTION

Embodiments of the invention generally relate to the fields of optical gratings. More particularly, embodiments of the invention relate to diffraction gratings suited for selecting an output wavelength of a laser.

### BACKGROUND

Diffraction gratings are used to select a desired wavelength to be amplified and ultimately emitted from a laser cavity. The gratings can be used in any of several types of general configurations (Littman-Metcalf, etc.) based on space constraints and bandwidth of the desired output. Various free space diffraction grating designs are known in the art. The performance of many conventional gratings is limited, particularly in the amount of light diffracted back into the laser gain medium, which impairs efficient lasing operation.

A diffractive grating structure consisting of a single periodic silver layer sandwiched between dielectric materials of index 1.5 was described by Mashev et al. in “Transmission grating for beam sampling”, Applied Optics, vol. 35, p. 3074, 1996 . In this case, both the reflected non-dispersed order, and the diffracted reflected order increase at the same rate as the non-dispersed light through the diffraction grating decreases, with the actual values changing with the thickness of the silver layer.

Accordingly, there is a need for an optical grating structure which allows a better control of the diffracted and transmitted beam energy and which allows the grating to operate as an optically efficient dispersive laser feedback device and as an output coupler without dispersion on the output beam.

### BRIEF SUMMARY OF THE INVENTION

According to one aspect of the invention, an optical grating includes a substrate having first and second major surfaces and being transparent to optical radiation, a first metal layer formed as a pattern of mutually parallel, spaced-apart first stripes disposed between the first and second major surfaces, and a second metal layer formed as a pattern of mutually parallel, spaced-apart second stripes disposed between the first metal layer and the second major surface. The first and second stripes define a common grating period and are arranged such that each first stripe substantially overlaps with a space formed between adjacent second stripes.

According to another aspect of the invention, a method for producing an optical grating includes the steps of etching a groove structure having uniformly spaced grooves of predetermined depth and predetermined width in a substrate transparent to optical radiation, with the etching producing sidewalls having a predetermined angle with respect to a major surface of the substrate, depositing a metal layer of predetermined thickness onto the etched groove structure so as to predominantly deposit the metal on top and bottom surfaces of the groove structure while minimizing metal deposits on the sidewalls, and depositing a layer of a dielectric material transparent to optical radiation onto the metal layer so as to at least fill the etched grooves.

Embodiments of the invention may include one or more of the following features. The width of the first stripes may be substantially identical to or different from the width of the second stripes. The first and second stripes may be made of aluminum or another metal with suitable optical properties in the wavelength range of interest. The first and second stripes may have the same thickness. The thickness is selected so that at least 50% of the incident optical energy is transmitted. The dielectric material is silicon dioxide (SiO₂), but may also include other dielectrics, such as silicon nitride, silicon oxinitride, aluminum oxide, sapphire and the like.

The angle of the grooves with respect to the major surface of the substrate may be 90° or less than 90°, for example, between about 45° and about 90°, or between about 70° and about 90°. The grooves are delineated by a photolithographic process or produced by a different, for example, directional etching method, such as electron beam etching. The metal layer may likewise be deposited by a directional deposition process. The top and bottom surfaces of the groove structure are preferably substantially flat and parallel to the major surface of the substrate.

The grating structure of the invention also allows for low power dispersive and/or non-dispersive monitoring of the laser output as well. Specific designs are shown for a 405 nm laser cavity to allow for the selection of a single wavelength of a single polarization. The invention, however, is not limited to 405 nm laser operation. Useful devices employing the same design principle can be made for wavelengths between deep UV (about 193 nm) and far-infrared (about 10 microns or more).

### BRIEF DESCRIPTION OF THE FIGURES

Other features and advantages of the present invention will be more readily apparent upon reading the following description of currently preferred exemplified embodiments of the invention with reference to the accompanying drawing, in which:

FIG. 1 shows a conventional tunable laser cavity with a transmission grating;

FIG. 2 illustrates the various orders in transmission/reflection;

FIG. 3 shows an exemplary embodiment of a transmission grating according to the invention with two discontinuous, uniformly spaced periodic metal layers;

FIGS. 4A-4C show a sequence of processing steps for producing the grating of FIG. 3;

FIG. 5 illustrates another exemplary embodiment of a transmission grating according to the invention similar to FIG. 3;

FIGS. 6-8 show contour plots of performance characteristics of the structure of FIG. 3 for the various reflected and transmitted beams; and

FIG. 9 shows an exemplary embodiment of a transmission grating with two discontinuous periodic metal layers and sloped sidewalls.

### DETAILED DESCRIPTION OF EXEMPLARY EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

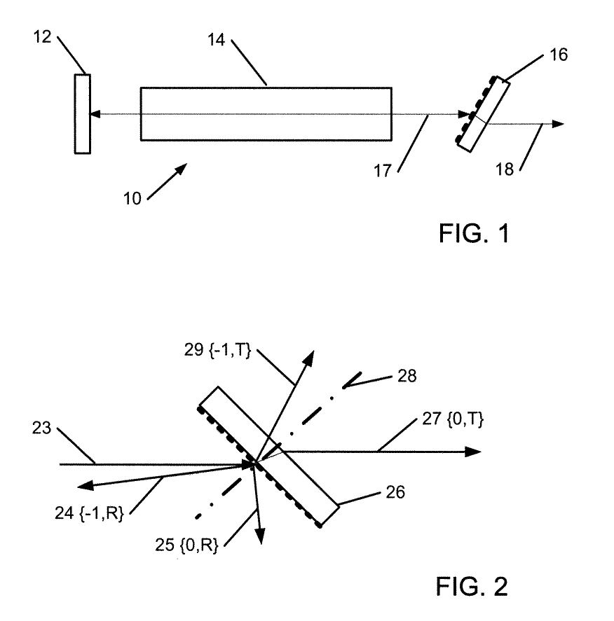

Turning now to the drawing, and in particular to FIG. 1, there is shown in form of a schematic diagram a conventional laser 10 having a gain section 14 that is wavelength-tuned by a transmission grating 16. A feedback mirror 12 retroreflects light beam 17 back into the cavity 14 for amplification. The output grating 16 partially retroreflects laser light back into cavity 14, with most of the intensity transmitted through output grating 16, for example, in 0^{th} order as output beam 18.

The attributes of grating 16 can be selected for polarization of the output light, diffraction efficiency into various orders, and diffraction angles. Grating dispersion is governed by the known grating equation:

mλ/d=sin(α)+sin(β) (Eq. 1)

wherein m=diffraction order, λ=the wavelength of interest, d=the periodic groove spacing of the grating, α=the angle of incidence of the light onto the grating, relative to the grating surface normal, β=the angle of diffraction of the light leaving the surface of the grating, relative to the grating surface normal.

The magnitude of the angular dispersion, which is defined as the change in diffraction angle with a change in wavelength, is:

dβ/dλ=m/(cos β*d) (Eq. 2)

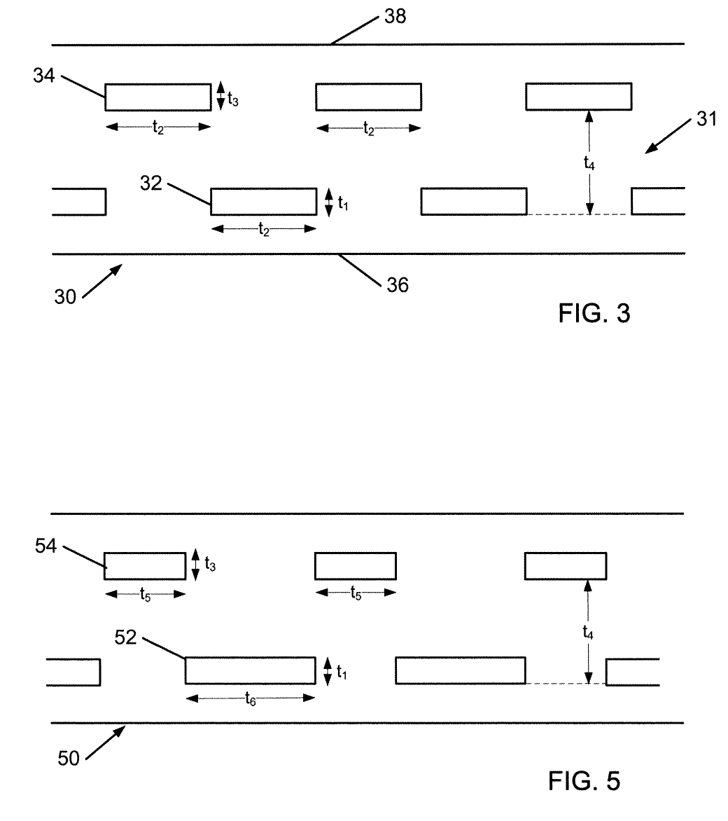

Turning now to FIG. 2, the following definitions will be used throughout the description:

{−1,R} (labeled 24) is the Littrow-retroreflected diffraction order that diffracts the wavelength of interest back into the cavity;

{0,R} (labeled 25) is the reflected 0^{th} order beam, without dispersion;

{0,T} (labeled 27) is the 0^{th} order beam transmitted through the grating without dispersion; and

{−1,T} (labeled 29) is the diffracted beam on the output side of the diffraction grating.

It should be noted that the index “−1” does not indicate the diffraction order.

The portion of light 24 diffracted a back toward the gain medium for further amplification is {−1, R}. Unwanted diffraction orders are blocked from re-entry into the laser cavity.

The light that is directed to a grating may be of a single polarization or a combination of two orthogonal polarizations generally called TE (for transverse electric), and TM (for transverse magnetic). Diffraction efficiencies of traditional gratings are generally different for different polarization directions of the incident light.

Typically only the beams 24 {−1, R} and 27 {0, T} should contain energy. In addition, for example, beam 29 {−1, T} could be employed to monitor beam intensity. If beam monitoring is not desired, then the most efficient diffractive system would be designed so that the {−1,R} order contains the energy required for proper operation of the laser cavity, while most of the remaining light would be in the non-dispersive laser output beam {0, T}.

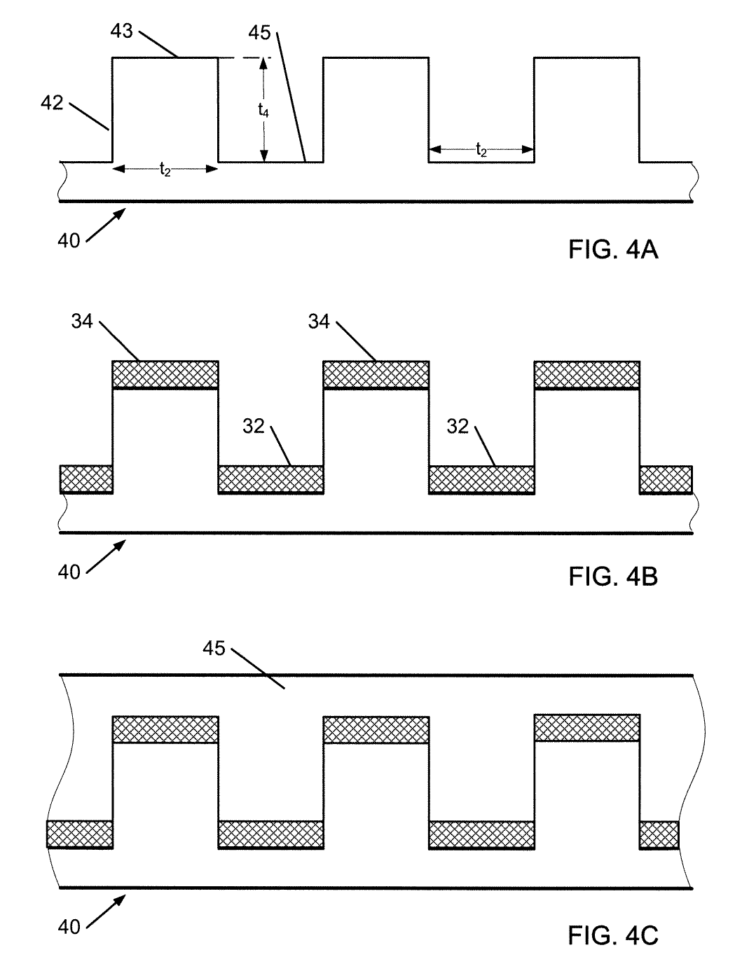

An exemplary embodiment of a transmission grating 30 according to the invention that provides sufficient back-diffraction into the laser gain medium to ensure proper laser operation and also provides a high-power undiffracted output beam is illustrated in FIG. 3 in a cross-sectional view taken perpendicular to the grating lines. The particular grating parameters were optimized for a laser of the type illustrated in FIG. 1 and operating near 400 nm.

The structure of the grating 30 is composed of a dielectric matrix 31 of a predetermined index and two layers of thin mutually parallel metal stripes 32, 34 spaced apart by a distance t₄. The stripes 34 in the top layer are arranged so to overlap with gaps between the stripes 32 in the bottom layer. In this exemplary embodiment, the stripes 32 and 34 in the two layers have the same width t₂ and are uniformly spaced, with the width equal to the gap between the stripes in each layer. The thickness of the stripes normal to the grating surface is t₁ for the stripes 32 in the bottom layer and t₂ for the stripes 34 in the top layer. The exposed surfaces 36, 38 of the dielectric matrix are bounded by air. In certain embodiments, a different dielectric material or a semiconductor material may be used instead of the material.

The amount of light in unwanted orders and the efficiency in the desired orders can be selected by choosing a suitable thickness and width of the metallic stripes, as well as index of refraction of the dielectric materials surrounding the metallic stripes. The {0, R} order is effectively suppressed and the {−1, T} order does not carry appreciable energy with a symmetrical index, i.e., when the index of refraction is identical for both sides of the grating structure.

The exemplary grating according to the invention will now be described in more detail. The metallic stripes 32 and 34 are designed to have an identical thickness t₁=t₃=6 nm and a width t₂=200 nm, meaning they are separated by a gap of also t₂=200 nm. Accordingly, the grating period in a single layer is 400 nm. The “layers” having the different stripes 32 and 34 are spaced by t₄=80 nm. With this design, the {−1,R} order diffracts approximately 20% of the incident light back into the gain medium, with approximately 60% of the energy to pass through the grating as the laser output beam{0, T}. At most 4% of the incident light is reflected as the {0, R} order. It should be noted that a continuous metal layer with a thickness of between approximately 5 nm and approximately 8 nm, preferably about 6 nm, and made of aluminum would be about 50% transparent to optical radiation wavelengths around 400 nm.

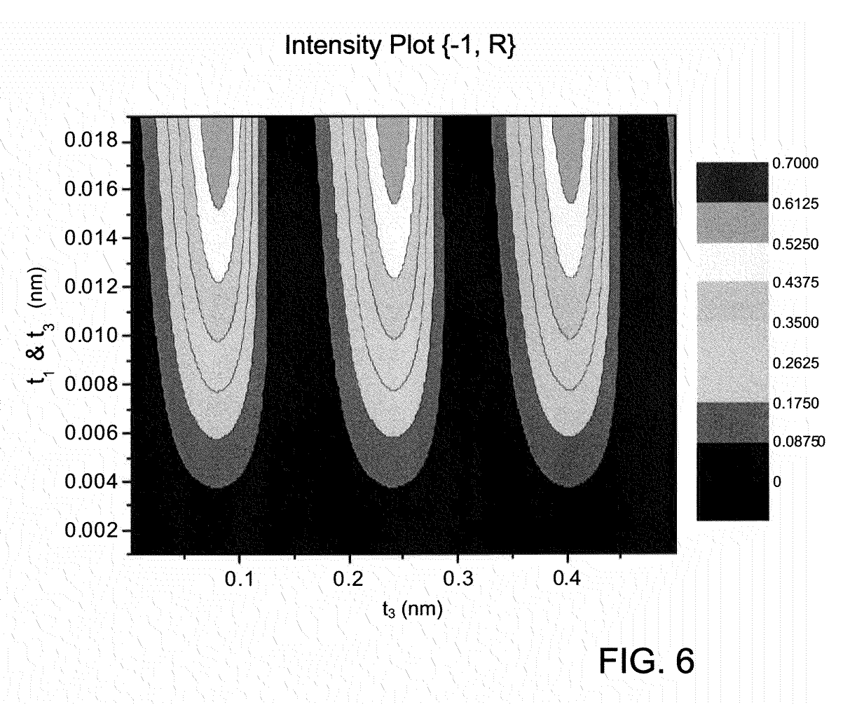

FIGS. 4A-4C show the processing steps for fabricating a grating according to the invention for a design wavelength of 405 nm and TE polarization. SiO₂ was used as dielectric materials for the matrix 31. The metal stripes 32, 34 were made of aluminum.

In a first step shown in FIG. 4A, a photoresist pattern delineating stripes with a width of 200 nm and a period of 400 nm is formed using standard lithographic processes on the surface of a glass or quartz substrate 40 (SiO₂), which is then directionally etched to form grooves with a depth of 80 nm having vertical walls 42. The top surfaces 43 and the groove bottoms 45 of the etched structure is then directionally coated with aluminum, for example by electron beam evaporation, to a thickness of approximately 6 nm, while preventing the side walls of the grooves to be coated with the metal. This process forms the stripes 32, 34 arranged in two spaced-apart planes, a shown in FIG. 4B. In a final step shown in FIG. 4C, the structure of FIG. 4B is coated with a layer 45 of SiO₂ in a non-directional coating process with an additional thickness of >300 nm. This step fills in the 80 nm deep grooves and eliminates most, if not all, of groove structure in the top surface 38 (FIG. 3). Any residual groove structure remaining after the last coating step, which may interfere with the desired diffraction efficiency performance, can be removed, for example, by polishing. Both SiO₂ surfaces 36, 38 in contact with air may be additionally antireflection-coated to reduce losses.

It will be understood that other dielectric, optically transparent materials can be employed for the substrate 40 and the coating 45, such as Si₃N₄, Al₂O₃, sapphire, and the like.

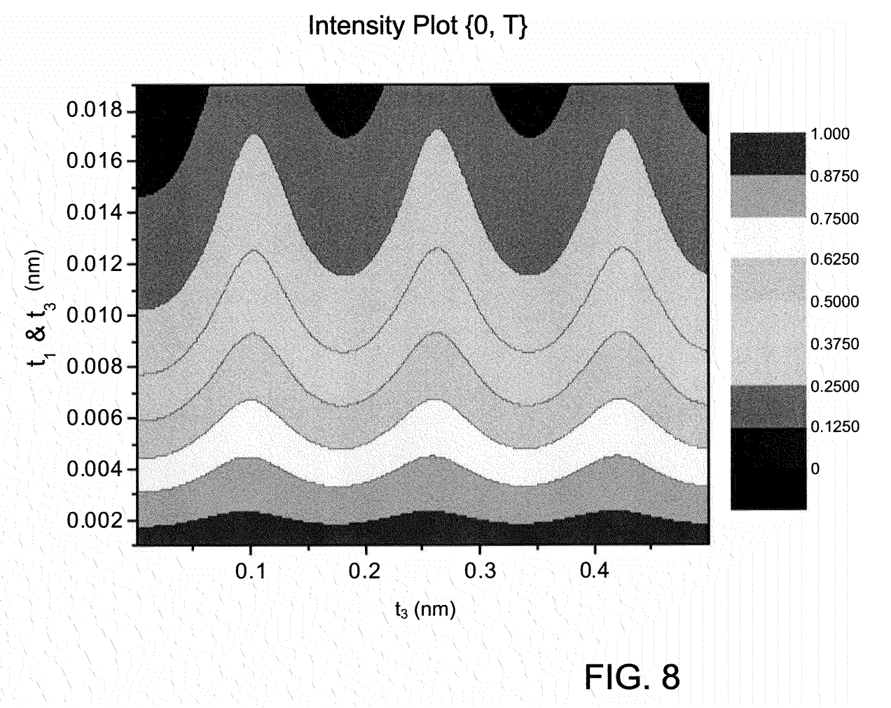

FIGS. 6-8 show intensity plots of computed efficiencies for the reflected orders {−1, R} (FIGS. 6) and {0, R} (FIG. 7), and the transmitted order {0, T} (FIG. 8) for 405 nm laser light and TE polarization. Plotted on the abscissa is the spacing t₄ between the layers having the stripes 32 and 34, respectively. The values on the ordinate indicate the thickness t₁, t₃ of the metal stripes which is taken to be identical. All values are expressed in micrometer (μm). The intensity levels are expressed as a fraction of the amount of available light and are indicated by the gray level in the intensity plots.

With the aforementioned design parameters of t₁=t₃=8 nm (=0.008 μm) and t₄=80 nm (=0.08 μm), the computed intensity values (as percentage of the incident intensity) are as follows:

| | | |
|---|---|---|
| {−1, R} | 18-26% | FIG. 6 |
| {0, R} | <4% | FIG. 7 |
| {0, T} | 50-60% | FIG. 8 |
| {−1, T} | <4% | — |

Gratings were fabricated using photolithography. The actual dimensions were measured by atomic force microscopy and are:
Line width t₂=200 nm (±10 nm) for a period of nominal 400 nm
Thickness t₃ of aluminum stripes: 6 nm
Groove depth t₄=82 nm
Dielectric 31: silicon dioxide (SiO₂)

Gratings fabricated using the nominal design parameters as stated above yielded actual measurements as follows:

| | |
|---|---|
| {−1, R} | 20% |
| {0, R} | <4% |
| {0, T} | 53% |
| {−1, T} | <4% |

The measured values are in excellent agreement with the computed values for all orders, indicating that the grating operates as predicted.

The grating structures can be fabricated using conventional processing methods, such as including lithography using masks, interference holography and the like. The thin metal coating for forming the stripes can be applied, for example, by thermal evaporation, e-beam evaporation, sputtering and the like. The various dielectric coatings and fill materials can likewise be deposited standard coating processes known in the art. The top surface 38 may be planarized, if necessary, using chemo-mechanical polishing and other conventional techniques.

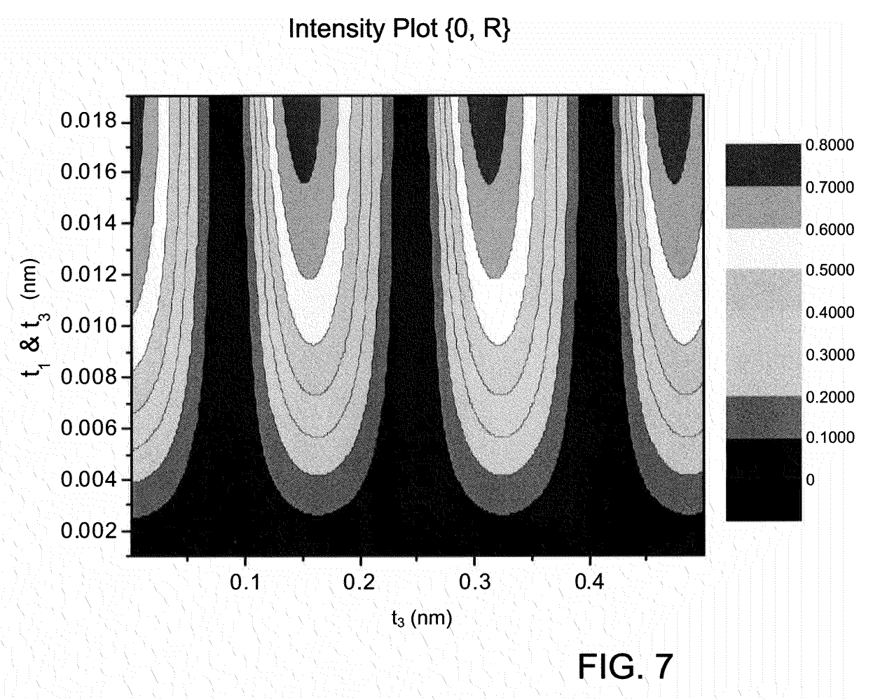

Returning now to FIG. 5, there is shown an exemplary embodiment of a double-layer grating 50 which, unlike the grating of FIG. 3, has metal stripes 52, 54 of unequal widths t₅ and t₆. In all other aspects, the two gratings 30 and 50 are of similar design; for example, the stripes 52 in one layer overlap with the openings between stripes 54 in the other layer, and vice versa. It can be expected that the grating performance can be “fine-tuned” by adjusting the widths t₅ and t₆.

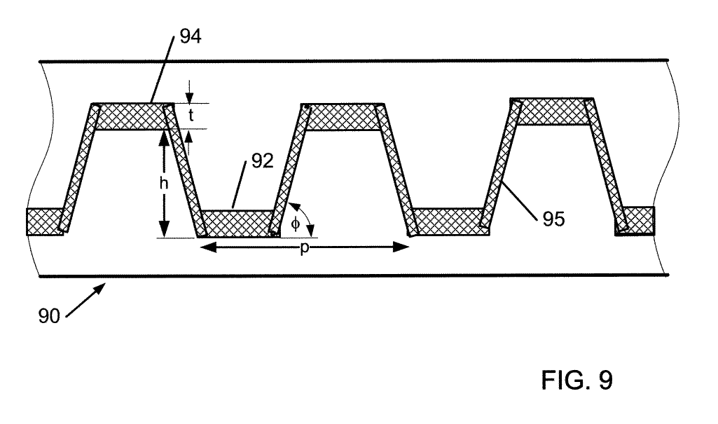

Turning now to FIG. 9, there is shown yet another embodiment of a double-layer grating 90 in which the etched sidewalls 95 are, unlike the sidewalls 42 depicted in FIG. 4A, sloped, forming an angle φ with the surface normal. It will be assumed that metal stripes 92, 94 of thickness t are deposited at the bottom and on top of the grooves with a vertical spacing h, and that substantially less metal is deposited on the sloped surfaces. The period of the grating is p. The depth in the following Table was optimized to achieve approximately 20% diffraction efficiency in the {−1, R} order.

| φ | h (nm) | t (nm) | {−1, R} | {0, R} | {0, T} |
|---|---|---|---|---|---|
| 90° | 86.4 | 6.4 | 20% | 0.4% | 62% |
| 80° | 90 | 6.4 | 20.6% | 0.08% | 61.7% |
| 70° | 100 | 6.2 | 20% | 0.2% | 60.9% |
| 60° | 110 | 6.2 | 20.2% | 0.18% | 60.7% |
| 45° | 138.9 | 6.2 | 20.4% | 2% | 58% |

As seen from the results listed in the Table, the double-layer grating can still attain the desired performance even with sloped sidewalls by adjusting the spacing h between the two layers where the stripes 92, 94 are formed.

While the invention has been illustrated and described in connection with currently preferred embodiments shown and described in detail, it is not intended to be limited to the details shown since various modifications and structural changes may be made without departing in any way from the spirit and scope of the present invention. For example, the step of overcoating the metal stripes with a SiO₂ layer (FIG. 4C) may be omitted, so that the top “dielectric” is air. Alternatively, only one of the metal layers (e.g., 34) may include the periodic stripe pattern, with the second layer being continuous. In other embodiments, the etched wall may be sloped, either intentionally or as a consequence of the etching process. While the grating of the invention employs aluminum as a metal, those skilled in the art will appreciate that other metals with suitable optical properties (e.g., absorption) can be employed.

The illustrated embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. An optical grating comprising:
a substrate having first and second major surfaces and being transparent to optical radiation,
a first metal layer formed as a pattern of mutually parallel, spaced-apart first stripes disposed between the first and second major surfaces, and
a second metal layer formed as a pattern of mutually parallel, spaced-apart second stripes disposed between the first metal layer and the second major surface,
wherein the first and second stripes define a common grating period and are arranged such that each first stripe substantially overlaps with a space formed between adjacent second stripes.

2. The optical grating of claim 1, wherein the first stripes have a substantially identical first width and the second stripes have a substantially identical second width identical to the first width.

3. The optical grating of claim 1, wherein the first stripes have a substantially identical first width and the second stripes have a substantially identical second width that is different from the first width.

4. The optical grating of claim 1, wherein the first and second stripes have identical thickness.

5. The optical grating of claim 1, wherein the substrate transparent to the optical radiation is a dielectric material.

6. The optical grating of claim 5, wherein the dielectric material is silicon dioxide (SiO₂).

7. The optical grating of claim 1, wherein the first and second metal layers are made of aluminum.

8. The optical grating of claim 1, wherein the aluminum layers each have a thickness selected to have for a continuous layer a transparency of at least 50% for a wavelength of the optical radiation.

9. The optical grating of claim 8, wherein the thickness of the aluminum layers is between approximately 5 nm and approximately 8 nm.

10. A method for producing an optical grating, comprising the steps of:
etching a groove structure having uniformly spaced grooves of predetermined depth and predetermined width in a substrate transparent to optical radiation, said etching producing sidewalls having a predetermined angle with respect to a major surface of the substrate,
depositing a metal layer of predetermined thickness onto the etched groove structure so as to predominantly deposit the metal on top and bottom surfaces of the groove structure while minimizing metal deposits on the sidewalls, and
depositing a layer of a dielectric material transparent to optical radiation onto the metal layer so as to at least fill the etched grooves.

11. The method of claim 10, wherein the angle is between about 45° and about 90°.

12. The method of claim 10, wherein the angle is between about 70° and about 90°.

13. The method of claim 10, wherein the angle is about 90°.

14. The method of claim 10, wherein the grooves are delineated by a photolithographic process.

15. The method of claim 10, wherein the top and bottom surfaces of the groove structure are substantially flat and parallel to the major surface of the substrate.

16. The method of claim 10, wherein the metal layer is deposited by a directional deposition process.

17. The method of claim 10, wherein the metal layer comprises aluminum.

18. The method of claim 10, wherein the substrate comprises silicon dioxide (SiO₂).

19. The method of claim 10, wherein the layer of deposited dielectric material comprises silicon dioxide (SiO₂).
